(19) United States
(12) Patent Application Publication
(10) Pub. No.: US 2001/0046710 A1
(43) Pub. Date: Nov. 29, 2001

(54) Narcotics detector test strips for a beverage

(76) Inventor: Charlyne E. Cutler, Las Vegas, NV (US)

Correspondence Address: Charlyne Cutler, Guardian Angel Test Kits, 1027 S. Rainbow Blvd. PMB# 282, Las Vegas, NV, 89145, US

(21) Appl. No.: 09/774,132

(22) Filed: Jan. 31, 2001

Related U.S. Application Data
(60) Provisional application No. 60/180,152, filed on Feb. 4, 2000.

(51) Int. Cl. G01N 31/22

(52) U.S. Cl. 436/24; 436/169; 436/901; 422/56

(57) ABSTRACT

Using a carrier such as a test strip, toothpick, cotton swab, etc, to detect the presence of Narcotics or impurities in a beverage. Using this method of on the spot detection was conceived while trying to think of a way to prevent Date Rapes and assaults do to a “mickey” being slipped into an unattended beverage. Trying to prevent ingestion of the drug became the most logical solution to fight this type of crime.

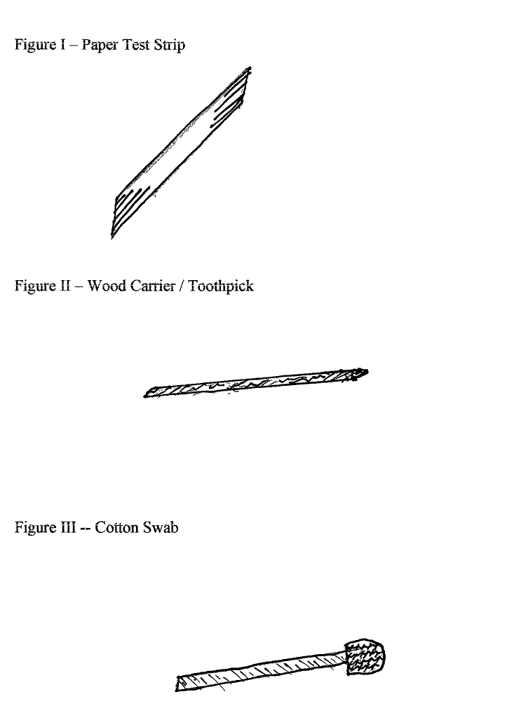

Using a chemically treated object/carrier, not limited to but including (1) a paper strip (test strip) or (2) wood sticks (toothpicks), or a (3) cotton swab, to pretest a beverage or consumable for suspected narcotics and/or impurities. The carrier is soaked with a solution created to undergo a visual color change when in contact with said narcotic/impurity, then it is left to dry. When the solution is dry the carrier becomes an on the spot detection device to test for the Narcotic and/or impurity which may be present in the liquid/beverage. The (1) test strip undergoes an immediate color change if inserted into a beverage/liquid that positively contains an impurity or Narcotic. By using a carrier that absorbs the responder chemicals, it allows a possible indefinite shelf life without being effected by heat and/or cold. There is also the advantage of on the spot detection as a presumptive for law enforcement and potential victims used as a crime prevention tool.

A specific solution C-3 has been created to detect the specific Schedule II Narcotic GHB (Gamma-Hydroxy Butyiate). By mixing a chemical recipe containing but not limited to Cuprous Chloride, Copper Acetate, Tannic Acid Ammonium Nitrate, Ferric Ammonium Sulfate, Ferric Chloride, we were able to detect GHB consistently using the above mentioned procedure.

### CROSS-REFRENECE TO RELATED APPLICATIONS

Only the provisional application originally filed Feb. 4, 2000 U.S. Pat. No. 60/180,152, in which I am submitting these changes for,

### STATEMENT REGARDING FEDERALLY SPONSORED RESEARCH OR DEVELOPMENT

### Not Applicable

### REFERENCE TO A MICROFICHE APPENDIX

### Not Applicable

### BACKGROUND OF THE INVENTION

Date Rape drugs have been being slipped into drinks for decades. Recently a new drug GHB has become an epidemic in America. The idea of the Narcotic detecting Test Strip for a beverage arose when Charlyne Cutler, sole-inventor, was watching a crime report on GHB Date Rape. With convenience and economics in mind, using a small piece of paper (test strip) or such, to detect the drug in a beverage came to mind. The idea was written down and contemplated. Without a chemical background Charlyne consulted with many scientists to create C-3, a solution which consistently responds in the presence of GHB, a clear drug commonly used to commit Date Rapes & Assaults.

### BRIEF SUMMARY OF THE INVENTION

We have created a chemical mixture (C-3) which consistently responds to GHB through instant color change. This is a unique way to crime prevention. The object of this invention is to be able to pretest a beverage for the presence of a Narcotic and or impurity before consumption. This should make the crime statistics drop immensely.

A convenient carrier is the only way people would actually use it. That is why an object such as (1) a test strip, (2) toothpick, or (3) cotton swab would be the best choice. This tool can be used to detect a variety of Narcotics and or an impurity depending on the chemical mixture that is absorbed into the carrier.

### BRIEF DESCRIPTION OF THE SEVERAL VIEWS OF THE DRAWINGS

1. FIG. I is a sample paper test strip.

2. Figure II is a sample if a wood carrier/toothpick.

3. Figure III is a sample of a cotton swab.

### DETAILED DESCRIPTION OF THE INVENTION

A chemical solution (C-3) of xxx Ferric Ammoniumn Sulfate, xxx Ferrous Sulfate, xxx Sodiumn Thiosulfate, xx Ammonium Nitrate is created. Once mixed together, the solution is filtered and then absorbed into a carrier such as a piece of paper 0.25″×2.5″.

Once dried the carrier as seen in Figure I, II, and III, becomes a detector for Narcotics and impurities.

What I, Charlyne Cutler, claim(s) my invention is:

1. I claim to be the first to use the method of using a chemically treated carrier to dip/pretest in to any beverage, liquid or consumable for instant detection of the presence of Narcotics and/or impurities.

2. I claim to be the first to obtain the recipe for C-3 as a chemical component that responds to GHB and its precursors.
